(19) United States
(12) Patent Application Publication
(10) Pub. No.: US 2019/0061254 A1
(43) Pub. Date: Feb. 28, 2019

(54) MOVEABLE BELT TO CARRY A BUILD MATERIAL

(71) Applicant: HEWLETT-PACKARD DEVELOPMENT COMPANY, L.P., Houston, TX (US)

(72) Inventors: Randall Dean West, Vancouver, WA (US); Samuel A. Stodder, Carlsbad, CA (US)

(21) Appl. No.: 16/090,746

(22) PCT Filed: Apr. 22, 2016
(86) PCT No.: PCT/US2016/028876

§ 371 Date: Oct. 2, 2018

(51) Int. Cl. B29C 64/321; B29C 64/165; B29C 64/295; B29C 64/214; B29C 64/245

(52) U.S. Cl. CPC B29C 64/321; B29C 64/165; B33Y 10/00; B29C 64/214; B29C 64/245; B29C 64/295

(57) ABSTRACT

In some examples, a printing system includes a bed on which layers of a three-dimensional (3D) object are to be formed, a moveable delivery platform, and a moveable belt to carry a build material and to deposit the build material onto the delivery platform. An actuator is to move the delivery platform from a lowered position to a raised position to allow spreading of the deposited build material on the delivery platform to the bed.

### BACKGROUND

A three-dimensional (3D) printing system can be used to form 3D objects. A 3D printing system performs a 3D printing process, which is also referred to as an additive manufacturing (AM) process, in which successive layers of material(s) of a 3D object are formed under control of a computer based on a 3D model or other electronic representation of the object. The layers of the object are successively formed until the entire 3D object is formed.

### BRIEF DESCRIPTION OF THE DRAWINGS

Some implementations of the present disclosure are described with respect to the following figures.

FIG. 1 is a schematic diagram of a portion of the printing system according to some examples.

FIG. 2 is a top view of a portion of a printing system according to some examples.

FIG. 3 is a schematic side view of a portion of a printing system according to further examples.

FIG. 4 is a plan view of a portion of a conveyor belt according to some examples.

FIG. 5 is a schematic perspective view of a portion of a printing system according to further examples.

FIG. 6 is a rear perspective view of a printing system according to other examples.

FIG. 7 is a flow diagram of a process of forming a printing system, according to some examples.

### DETAILED DESCRIPTION

In a 3D printing system, a build material (or multiple different build materials) can be used to form a 3D object, by depositing the build material(s) as successive layers until the final 3D object is formed. In some examples, a build material can include a powdered build material that is composed of particles in the form of fine powder or granules. The powdered build material can include metal particles, plastic particles, polymer particles, or particles of other materials.

Build material(s) can be transported from a build material reservoir (or multiple build material reservoirs) of the printing system to a printing bed (or more simply “bed”) of the printing system, where layers of the build material(s) are formed on the bed. A build material is delivered in metered amounts and at specified temperatures. In example printing systems, the powdered build material can be spread in a plane along two perpendicular axes (such as an x axis and a y axis) across the printing bed. The printing bed can also be referred to as a build platform.

In accordance with some implementations of the present disclosure, a 3D printing system includes a build material delivery system that includes a moveable conveyor belt to carry a build material from a build material reservoir to a location of the printing system where the powdered material can be spread onto a printing bed of the printing system. The build material reservoir may be located below the printing bed.

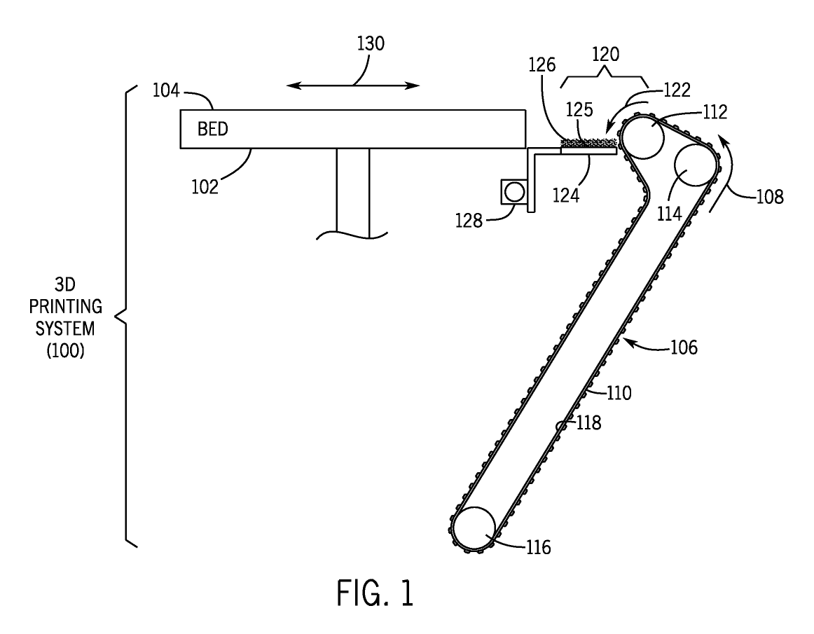

FIG. 1 shows a portion of a 3D printing system 100 according to some implementations. The 3D printing system 100 includes a printing bed (or build platform) 102 that has a flat upper surface 104 on which a build material (or multiple build materials) can be provided in layers as part of a 3D printing operation. The printing system 100 further includes a moveable conveyor belt 106 that can be moved in a circulating manner, along circulating direction 108. A “conveyor belt,” or more simply a “belt,” can refer to a transport structure having a transport surface on which a print material can be provided for transport between different locations; note that further structures can be formed on the transport surface, where such further structures can define cavities in which the print material can be received for transport. Such further structures are described further below.

The outer surface 110 of the belt 106 is used to carry a build material as the belt 106 circulates. A circulating belt refers to a belt that moves in a closed loop on a continual basis. In other examples, other types of moveable conveyor belts with other movement patterns can be used.

In the example of FIG. 1, multiple rollers 112, 114, and 116 are part of a drive system to move the belt 106. Although three rollers are shown in FIG. 1, it is noted that in other examples, less than three or more than three rollers can be employed as part of the drive system to move the belt 106.

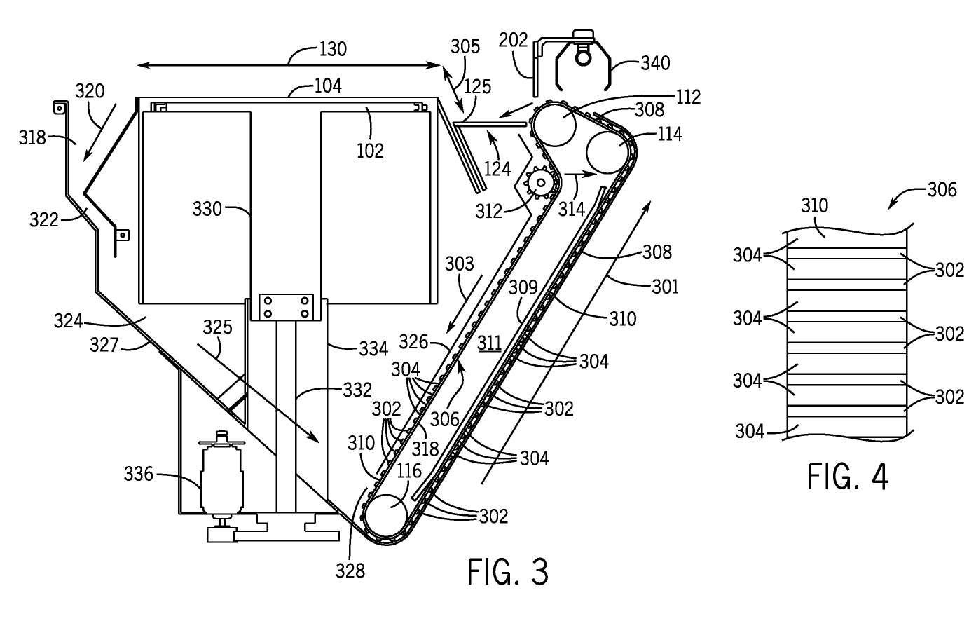

The outer surfaces of the rollers 112, 114, and 116 engage an inner surface 118 of the belt 106. At least one of the rollers 112, 114, and 116 can be driven (rotated) by a motor (not shown in FIG. 1) to cause movement of the belt 106 in the circulating direction 108. Although not shown in FIG. 1, an outer housing of the printing system 100 can be provided outside of the belt 106 such that the build material carried by the belt 106 can be trapped between the outer surface 110 of the belt 106 and the inner surface of the outer housing as the build material is transported by the belt 106. This outer housing is shown in FIG. 3, discussed further below.

The build material on the outer surface 110 of the belt 106 is transported to a delivery location (generally indicated as 120) where the build material is deposited generally as indicated by arrow 122 (due to gravity and the motion of the belt 108) onto an upper surface 125 of a moveable delivery platform 124. The powdered build material can be generally free flowing. The delivery platform 124 is moveable between a lowered position (the position shown in FIG. 1) and a raised position that is higher than the lowered position, where the top surface 125 of the delivery platform 124 can be level with or slightly higher than the upper surface 104 of the printing bed 102. In some examples, the delivery platform 124 is moveable along a vertical axis. In other examples, as discussed further below, the delivery platform 124 is moveable along a diagonal axis that is slanted or angled with respect to the vertical axis.

As shown in FIG. 1, the delivery platform 124 is in its lowered position, to allow the build material on the belt 106 to be deposited onto the upper surface 125 of the delivery platform 124 as the belt 106 moves past the delivery platform 124. The deposited build material is referenced as 126 in FIG. 1. A metered amount of build material can be deposited onto the delivery platform 124. Metering an amount of build material onto the delivery platform 124 refers to delivering a target volume of build material onto the delivery platform 124, where the metering can be based on a specified distance traveled by the belt 106, or a time of operation of the belt 106. Thus, the belt 106 can be moved a specified distance to deliver an amount of build material associated with this specified distance onto the delivery platform 124. As explained further below, the outer surface 110 of the belt 106 can be provided with a teeth profile, where cavities are defined by the teeth profile, with each cavity carrying a known volume of powdered build material.

After the metered amount of the build material 126 has been deposited onto the upper surface 125 of the delivery platform 124, the belt 106 can be stopped, and an actuator 128 can be activated to raise the delivery platform 124 to the raised position. At the raised position, the upper surface 125 of the delivery platform 124 on which the deposited build material 126 is provided is substantially at the same height as the upper surface 104 of the printing bed 102. Being “substantially at the same height” can mean that the upper surface 125 of the delivery platform 124 and the upper surface 104 of the printing bed 102 are aligned so that the deposited build material 126 can be pushed onto the upper surface 104 of the printing bed 102 from the upper surface of the delivery platform 124. The upper surface 125 of the delivery platform 124 being at “substantially the same height” as the printing bed upper surface 104 can refer to the upper surfaces 125 and 104 being at exactly the same height, or the upper surfaces 125 and 104 being at different heights but within some specified distance of one another.

The combination of the belt 106, rollers 112, 114, and 116, the delivery platform 124, and the actuator 128 (along with other components, such as the motor to drive the roller 112, 114, and/or 116) can be collectively considered to be a build material delivery system that is useable within the printing system 100. The build material delivery system is to transport a build material from a build material reservoir below the printing bed 102 to a delivery location (e.g. 120 in FIG. 1). With this arrangement, the powdered build material can be stored below the printing bed 102, which enables a compact (lower height) architecture (compared to printing systems where the powdered material is stored above the printing bed and is gravity fed to the printing bed).

After the delivery platform 124 has been moved by the actuator 128 to the raised position, a spreader (not shown in FIG. 1) can be used to spread the deposited build material 126 across the upper surface 104 of the printing bed 102. The spreading of the deposited build material 126 is along a spreading axis 130.

In some examples, spreading of the deposited build material 126 onto the printing bed 102 has to occur along just the single spreading axis 130, such that spreading along multiple axes does not have to be performed. Spreading in just one spreading axis simplifies the design of the printing system 100 by eliminating certain moving parts, and can make the printing operation more efficient.

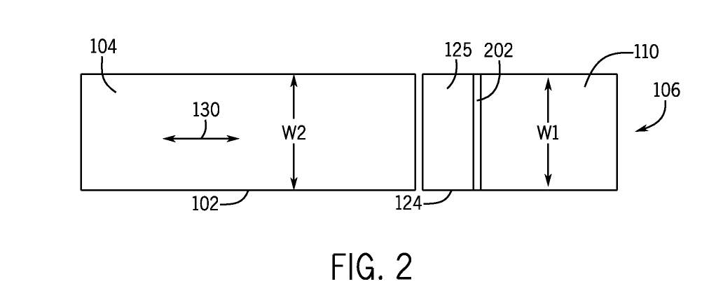

A top view of the 3D printing system 100 of FIG. 1 is shown in FIG. 2. The top view is a view of the 3D printing system 100 when viewed from above the printing system 100. FIG. 2 shows the outer surface 110 of the belt 106, the upper surface 125 of the delivery platform 124 (the deposited build material 126 is provided onto the upper surface 125 of the delivery platform 124), and the upper surface 104 of the printing bed 102. FIG. 2 also shows a spreader 202, which in the example is in the form of a moveable blade that is moveable along the spreading axis 130. In other examples, the spreader 202 can be in the form of a roller or can have any other structure that is able to contact the deposited build material 126 and spread the deposited build material 126 onto the printing bed upper surface 104 to form a layer of build material.

The outer surface 110 of the belt 106 has a width W1, and the printing bed upper surface 104 has a width W2. Each of the widths W1 and W2 extend along an axis that is perpendicular to the spreading axis 130 of the deposited build material 126. In one example, the width W1 of the outer surface 110 of the belt 106 is substantially equal to the width W2 of the upper surface 104 of the bed 102. The widths W1 and W2 may be considered substantially equal if the widths are within 5%, 10%, 15%, or 20% of each other. W1 can be greater than W2, equal to W2, or less than W2.

Although not shown, the width of the upper surface 125 of the delivery platform 124 can also be substantially equal to the width W2 of the upper surface 104 of the printing bed 102.

FIG. 3 is a side view of a 3D printing system 300, according to further examples. In FIG. 3, components that are similar to components of FIG. 1 are labeled with the same reference numerals. Although FIG. 3 shows a specific example arrangement of components of the printing system 300, it is noted that in other examples, other arrangements of components can be employed.

A conveyor belt 306 of the printing system 300 differs from the conveyor belt 106 of FIG. 1 in that the belt 306 has transport structures 302 that are formed on an outer surface 310 of the belt 306 (not all transport structures 302 are labeled in FIG. 3). The transport structures 302 can be in the form of protrusions that rise above the outer surface 310 of the belt 306. The transport structures 302 provide a teeth profile on the outer surface 310 of the belt 306.

A plan view of a portion of the belt 306 is shown in FIG. 4, where transport structures 302 are shown extending across the width of the outer surface 310 of the belt 306. A cavity 304 is provided between each successive pair of the transport structures 302. Each cavity 304 is able to receive a respective volume of build material. The belt 306 carries portions of build material(s) in respective cavities 304 formed between the transport structures 302 of the belt 306. The protrusions that form the transport structures 302 in some examples may extend outwardly from the outer surface 310 of the belt 306 in generally a direction that is perpendicular to the outer surface 310. In other examples, the protrusions that form the transport structures 302 may extend outwardly at an angle or incline from the outer surface 310 of the belt 306, which may be useful to keep the powdered build material in ache cavity 304 from falling from the cavity 304 when the powdered material is being carried at the upper inclined portion of the belt 306 (the inclined portion before the delivery location 120). In the latter examples, the incline of the protrusions can depend on the incline of the upper inclined portion of the belt 306.

As further shown in FIG. 3, an outer housing 308 of the printing system 300 is provided outside the outer surface 310 of the belt 306. The transport structures 302 are provided between the outer surface 310 of the belt 306 and an inner surface of the outer housing 308. The inner surface of the housing 308 makes contact with (or is sufficiently close to) the transport structures 302, such that a build material portion carried in each cavity 304 is maintained in the cavity 304 (i.e. does not move from the cavity 304 to somewhere else). In example arrangements according to FIG. 3, the belt 306 transports the build material in an upside down manner along a right portion of the circulating path. The housing 308 serves to prevent build material portions from falling out of the cavities 304 while the build material portions are in the upside down orientation.

Also, the housing 308 serves to level the build material in each cavity 304 such that a build material portion that fills the cavity 304 is level with the height of the transport structures 302. As a result, a uniform slug of build material is provided in each cavity 304, so that more accurate metering of a build material can be achieved when delivering the build material to the delivery platform 124. The metering can be accomplished by operating the belt 306 for a specified time interval, or based on emptying the content of a specified number of cavities 304 onto the delivery platform. The uniform slug of build material in each cavity 304 has a known volume, based on the distance of the spacing between successive transport structures 302, and based on the depth of the cavity, so that the printing system 300 can determine how much build material is deposited based on distance traveled by the belt 306 (or equivalently based on an amount of rotational movement of a roller 112, 114, or 116).

Although not explicitly shown in FIG. 3, it is noted that the inner surface 318 of the belt 306 can also include a teeth profile (similar to that of the outer surface 310 of the belt 306) to allow for better engagement between the rollers 112, 114, and 116 and the inner surface of the belt 106.

At least one of the rollers 112, 114, and 116 can have an outer surface with a gear profile (in the form of a toothed wheel), where protrusions of the geared outer surface(s) of the roller(s) can engage the teeth profile of the inner surface 318 of the belt 306, such that the belt 306 can be moved by rotation of the roller(s).

FIG. 3 further shows a support wall 309 provided in an inner region 311 within the belt 306. An inner surface of the support wall 309 is engaged to the inner surface 318 of the belt 306, and serves to guide a travel path of the belt 306. A portion of the belt 306 along a lift path 301 is thus provided between the support wall 309 and the outer housing 308 as the belt 306 circulates.

Another roller 312 is provided to engage the outer surface 310 of the belt 306 in the return path 303 of the belt 306. The roller 312 can have an outer surface with a gear profile to engage the teeth profile provided on the outer surface 310 of the belt 306 by the transport structures 302 and cavities. In some examples, the rollers 112, 114, and 116 can each have a gear profile similar to that of the roller 312.

The roller 312 is positioned to push one side of the belt 306 inwardly (in a direction indicated by 314) towards the other side of the belt 306. The presence of the roller 312 defines a recessed contour in the portion of the belt 306 against which the roller 312 is engaged. The recessed portion of the belt 306 moves away from the delivery platform 124 after passing the delivery platform 124.

The printing system 300 also includes the spreader 202, which is moveable along the spreading axis 130 after the delivery platform 124 has been moved to the raised position. In examples according to FIG. 3, the delivery platform 124 is moveable along a diagonal axis 305 between a lowered position and a raised position. The diagonal axis 305 is slanted or angled with respect to a vertical axis.

Any excess build material that is pushed by the spreader 202 across the printing bed upper surface 104 can be provided to a return chute 318, as indicated generally by arrow 320.

After the deposited build material 126 has been spread by the spreader 202 from the upper surface 125 of the delivery platform 124 to the printing bed upper surface 104, the delivery platform 124 can be moved from the raised position to the lowered position. Movement of the belt 306 can then be activated again, which causes a further portion of the build material to be delivered from the belt 306 to the delivery platform 124 in the lowered position. The delivery platform 124 can then be raised again to the raised position to allow the further portion of the build material to be spread by the spreader 202 to the printing bed upper surface 304.

Once a layer of the deposited build material 126 is formed on the printing bed upper surface 104 due to the spreading of the build material from the delivery platform 124 to the printing bed upper surface 304, a printhead (or multiple printheads), which are not shown, can deposit a liquid agent (or other suitable material) onto selected portions of the spread build material on the printing bed upper surface 104. Any portions of the layer of the build material onto which the liquid agent or other material is deposited can have the particles glued together, or such portions are further processed to transform the portions from a powdered form to a solid form. In other examples, instead of depositing a liquid agent, portions of the layer of the printing material can be exposed to a laser beam to produce a target image. In further examples, other types of processing can be applied to the layer of build material on the printing bed upper surface 104.

The depositing of the liquid agent can be based on a model of the 3D object that is to be formed, and can be controlled by a computer of the printing system 300. According to the 3D object model, the liquid agent can be deposited onto portions of the layer of build material to form a corresponding layer of the 3D object. Any unbound portion (a portion on which the liquid agent has not been deposited) of the build material on the printing bed upper surface 104 remains in powdered form, and can be removed in a process referred to as de-powdering. Any de-powdered build material can also be returned through the return chute 318.

The return chute 318 leads to a passageway 322 that extends to a build material reservoir 324 of the printing system 300. The reservoir 324 is arranged to store a build material that is to be transported by the conveyor belt 306 to the printing location 120 for delivery to the delivery platform 124.

Although just one build material reservoir 324 is shown in FIG. 3, it is noted that in other examples, the printing system 300 can include multiple build material reservoirs for holding multiple different types of build materials.

As further shown in FIG. 3, the printing system 300 includes an inner housing 326. The reservoir 324 is defined in part by the inner housing 326 and an outer housing 327. The belt 306 and the roller 312 are positioned on a first side of the inner housing 326 that is opposite to the second side of the inner housing 326 that defines the reservoir 324.

The inner housing 326 has a lower opening 328 through which the build material in the reservoir 324 can pass to the cavities 304 of the belt 306, generally along a direction indicated by arrow 325.

The printing bed 102 is attached to a piston 330 (or other support), where the piston 330 is moveable up and down on a piston rod 332. The piston rod 332 is surrounded by an outer shroud 334, to isolate the piston rod 332 from the build material in the reservoir 324. A motor 336 controls the up and down motion of the piston 330 on the piston rod 332.

As successive layers of build material are formed on the printing bed upper surface 104, the motor 336 can be actuated to lower the printing bed 102 by respective incremental amounts to corresponding different elevations, so that each successive layer of build material can be formed over the previously formed build material layer.

As further shown in FIG. 3, a heater 340 can be provided in a heating zone. In some examples, the heater 340 can be a heating lamp or another type of heating element. More generally, the heater 340 can use heat radiation or conduction to heat the build material being carried by the belt 306 to a target temperature. In examples according to FIG. 3, the heater 340 is attached to the spreader 202. In some examples, the heater 340 can be positioned above the belt transport where the structure 308 stops just after the turn around roller 114. This can allow direct radiative heating of the powder on the belt 306.

In other examples, the heater 340 can be attached to a different structure. The target temperature of the build material can be controlled by controlling the heater 340.

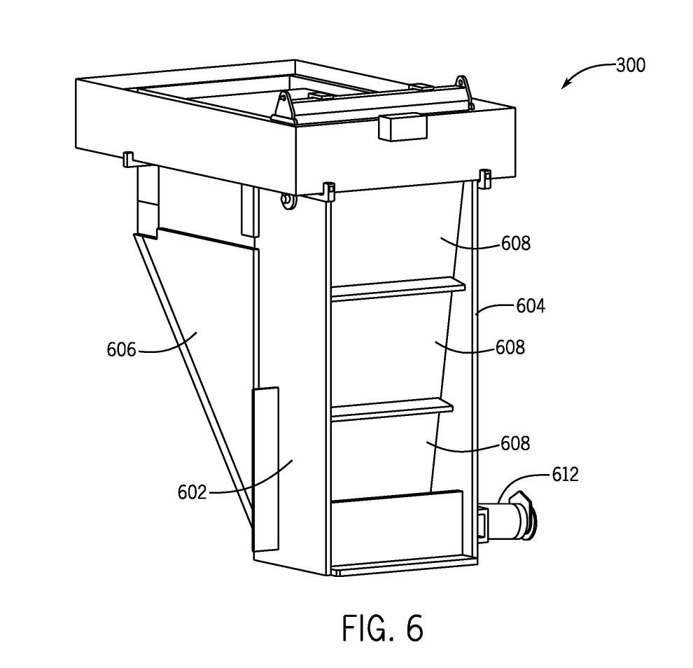

In other examples, a heater (or multiple heaters) can be provided at different locations for heating the build material on the belt 306, such as at locations shown in FIG. 6 (described further below).

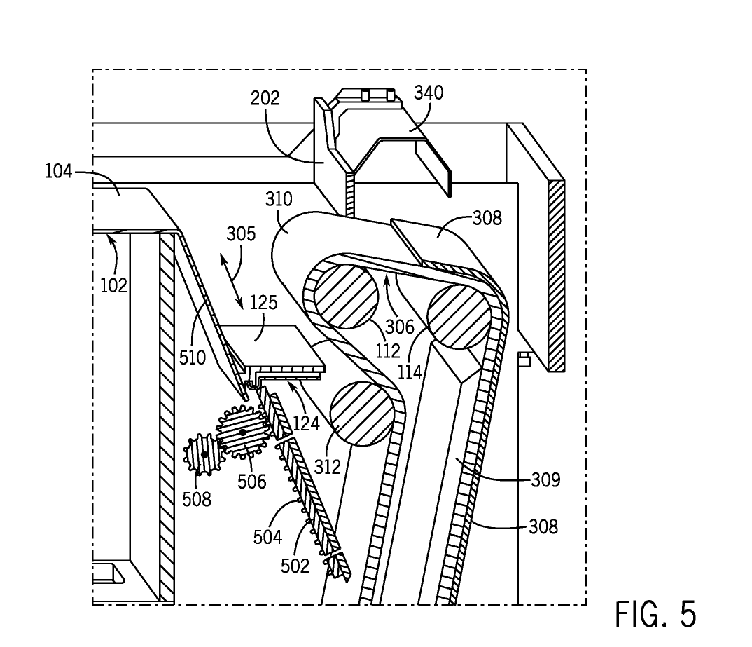

FIG. 5 is a perspective view of a portion of the print system 300 according to some examples. As shown in FIG. 5, the spreader 202 is in the form of a blade. However, in other examples, the spreader 202 can be a different type of structure.

In examples according to FIG. 5, the delivery platform 124 is movable along the diagonal axis 305. In the lowered position shown in FIG. 5, build material can fall from the outer surface 310 of the belt 306 onto the upper surface 125 of the delivery platform 124.

In examples according to FIG. 5, the delivery platform 124 has a gear rack 502. The gear rack 502 has a surface 504 with a teeth profile, which is engageable by a roller 506 that can have a gear profile on its outer surface. The roller 506 is driven by a motorized roller 508, which can also have a gear profile on its outer surface. The motorized roller 508 is rotated by a motor (not shown). The rollers 506 and 508 (along with the motor, not shown) can form part of the actuator 128 that is shown in FIG. 1.

Rotation of the roller 508 causes a corresponding rotation of the roller 506 which in turn engages the surface 504 of the gear rack 502 to cause movement of the gear rack 502 along the diagonal axis 305 as the roller 506 rotates. A counter clockwise rotational movement of the roller 506 causes a generally downward movement of the gear rack 502 along the diagonal axis 305. A clockwise rotational movement of the roller 506 causes the gear rack 502 to move upwardly along the diagonal axis 305.

A diagonal support wall 510 is provided along which the delivery platform 124 is moveable, until the delivery platform 124 is raised to its raised position such that the upper surface 125 of the delivery platform 124 is aligned with the printing bed upper surface 104.

FIG. 6 is a rear perspective view of the printing system 300 according to alternative implementations. In FIG. 6, various housing panels 602, 604, 606, and other panels are depicted, where such panels enclose the inner components of the printing system 300.

As further shown in FIG. 6, the printing system 300 includes film heaters 608 attached to the housing 308 (FIG. 3 or FIG. 5) that is slanted and is adjacent the belt 306. The film heaters 608 can be provided in the printing system 300 in place of or in addition to the heater 340 shown in FIG. 3 or 5. A film heater can include electrical heating elements that are heated by passing electrical current through the electrical heating elements. Although three film heaters 608 are shown in FIG. 6, it is noted that in other examples, a smaller number or larger number of film heaters can be arranged along the outer housing 308 of the printing system 300. In other examples, other types of contact heaters can be employed instead of or in addition to film heaters.

The film heaters 608 when activated can heat the outer housing 308 (FIG. 3 or 5), which in turn can cause heating of the build material portions carried in the cavities 304 of the conveyor belt 306.

By using a combination of the heating lamp 340 and the film heaters 608, a combination of heating techniques in different zones can be used. For example, heat conduction applied by the film heaters 608 can apply a shear force on the powdered build material as the powdered build material is dragged across a heated surface, e.g. the inner surface of the outer housing 308. Above certain temperatures, the powdered build material may not be able to support this shear force and may fuse or clump together. The powdered build material can be heated by conduction (such as with use of the film heater 608) until the temperature of the powdered build material reaches a threshold temperature. Once the heated powdered material that has been heated to the threshold temperature reaches a zone adjacent the heating lamp 340, then further heating can be applied by the heating lamp 340. By using a combination of heating techniques, the overall heating cost can be reduced since the cost of using heating lamps can be higher than the use of film heaters or other types of conductive heating elements.

FIG. 6 also shows a motor 612 that can be used to drive at least one of the rollers 112, 114, and 116 (FIG. 1 or 3) of the printing system 300 to move the belt 306. In some examples, the motor 612 can be used to drive rotational movement of the roller 116 (FIG. 1 or 3).

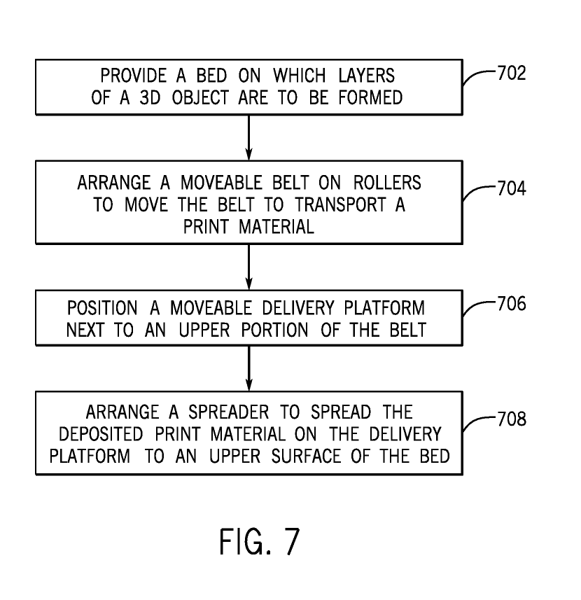

FIG. 7 is a flow diagram of an example method of forming a printing system, according to some implementations. The process of FIG. 7 includes providing (at 702) a bed (e.g. 102 in FIG. 1 or 3) on which layers of a 3D object are to be formed. The process of FIG. 7 further includes arranging (at 704) a moveable belt (e.g. 106 in FIG. 1 or 306 in FIG. 3) on rollers to move the belt to transport a build material. The belt includes transport structures that provide a measured amount of powdered build material based on operating the belt for a certain time period, or until a certain number of cavities defined by the transport structures have emptied their contents onto the delivery platform.

The process includes positioning (at 706) a moveable delivery platform (e.g. 124 in FIG. 1 or 3) next to an upper portion of the belt, the delivery platform moveable between a lowered position to receive a deposit of the build material from the belt, and a raised position. The process of FIG. 7 further includes arranging (at 708) a spreader to spread the deposited build material on the delivery platform to an upper surface of the bed.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A printing system comprising:
a moveable delivery platform;
a moveable belt to carry a build material and to deposit the build material onto the delivery platform; and
an actuator to move the delivery platform from a lowered position to a raised position to allow spreading of the deposited build material on the delivery platform to a bed on which layers of a three-dimensional (3D) object are to be formed.

2. The printing system of claim 1, wherein the belt includes protrusions on a surface of the belt, wherein a cavity between each successive pair of the protrusions is to hold a respective portion of the build material as the belt moves.

3. The printing system of claim 2, further comprising a reservoir of the build material, the build material in the reservoir to pass through an opening to the cavities between the protrusions of the belt as the belt moves.

4. The printing system of claim 1, further comprising a spreader that is moveable to spread the deposited build material from the delivery platform to the bed along a spreading axis.

5. The printing system of claim 4, wherein the belt has a width that is substantially equal to a width of the bed.

6. The printing system of claim 4, wherein the actuator is to move the delivery platform to a lowered position after the spreader has moved the deposited build material from the delivery platform, wherein the delivery platform in the lowered position is to receive further build material from the belt.

7. The printing system of claim 1, further comprising a support to move the bed to different elevations during a printing operation.

8. The printing system of claim 1, wherein the delivery platform is moveable between a lowered position and the raised position along a diagonal axis that is slanted with respect to a vertical axis.

9. The printing system of claim 1, further comprising a housing adjacent to the belt, the printing system further comprising a conductive heater attached to a housing to heat the build material on the belt.

10. The printing system of claim 9, further comprising a heater to apply radiation heating to the build material on the belt.

11. A build material delivery system for a printing system, comprising:
a delivery platform;
a moveable belt to carry a build material from a reservoir to the delivery platform; and
a spreader to spread the build material along a single spreading axis from the delivery platform onto a printing bed of the printing system, wherein the belt has a width that is substantially equal to a width of the printing bed, the width of the belt along a direction that is perpendicular to the spreading axis.

12. The build material delivery system of claim 11, wherein the belt includes protrusions on a surface of the belt, wherein a cavity between each successive pair of the protrusions is to hold a respective portion of the build material as the belt moves.

13. The build material delivery system of claim 11, wherein the delivery platform is moveable between a lowered position and a raised position, the belt to deposit a portion of the build material onto the delivery platform when the delivery platform is in the lowered position, and the spreader to spread the deposited portion of the build material from the delivery platform to the printing bed when the delivery platform is in the raised position.

14. The build material delivery system of claim 13, wherein the belt is moveable in a circulating manner to carry the build material from a reservoir to a delivery location to deliver the build material to the delivery platform.

15. A method of forming a printing system, comprising:
providing a bed on which layers of a three-dimensional (3D) object are to be formed;
arranging a moveable belt on rollers to move the belt to transport a build material, the belt comprising transport structures to provide a measured amount of a build material;
positioning a moveable delivery platform next to an upper portion of the belt, the delivery platform moveable between a lowered position to receive a deposit of the build material from the belt, and a raised position; and
arranging a spreader to spread the deposited build material on the delivery platform to an upper surface of the bed.
